(19) United States
(12) Patent Application Publication
(10) Pub. No.: US 2003/0091271 A1
(43) Pub. Date: May 15, 2003

(54) Non-blocking switching arrangements with minimum number of 2x2 elements

(76) Inventor: Corrado P. Dragone, Little Silver, NJ (US)

Correspondence Address: John A. Caccuro, 9 Ladwod Drive, Holmdel, NJ, 07733, US

(21) Appl. No.: 10/273,570

(22) Filed: Oct. 17, 2002

Related U.S. Application Data
(62) Division of application No. 09/629,299, filed on Jul. 31, 2000, now abandoned.

(51) Int. Cl. G02B 6/26

(52) U.S. Cl. 385/20; 385/15; 385/16

(57) ABSTRACT

A 4×4 nonblocking switch arrangement includes eight 2×2 switches. The switch is nonblocking in that it is characterized by an algorithm that allows the destination of any two input signals to be interchanged by only changing the setting of one particular 2×2 switch. By removing one signal path a nonblocking 3×3 switch is obtained. Both switches have the minimum number of elements. These arrangements can be used as building blocks to construct larger switches and can be dilated to minimize crosstalk.

### TECHNICAL FIELD OF THE INVENTION

The present invention relates to a non-blocking switching network and, more particularly, to a switch implemented in non-dilated or dilated form using a minimum number of 2×2 switch elements.

### BACKGROUND OF THE INVENTION

In high capacity optical networks, an essential device is an N×N crossconnect network. Such N×N crossconnect networks are typically constructed using smaller switches as building blocks. Often the basic building block is a 2×2 switch element that can be realized in a variety of different ways [1-12] including for instance mechanical switches, or integrated switches in which the optical signals can be switched using, for instance, the electrooptic effect. (Note in this specification, a reference to another document is designated by a number in brackets to identify its location in a list of references found in the Appendix)

Each 2×2 switch element is characterized by two states. One of these, known as the cross state, interchanges the two input signals, whereas the other state, known as the bar state, leaves the order of the two signals unchanged. Each input signal may include several wavelength channels. For instance the 2×2 switch may be a channel adding/dropping arrangement [11,12]. The switch is then capable of independently interchanging any two input channels of the same wavelength. If then Q is the number of wavelengths, the switch must include Q independent controls, one for each wavelength, and any pair of input channels of the same wavelength can then be interchanged by using a particular control.

To implement an N×N nonblocking switching network, a standard crossbar arrangement requires at least N² 2×2 switch elements. For large N, to minimize crosstalk the network arrangement must also be dilated [2,6,7]. However, a dilated N×N nonblocking switching network requires additional 2×2 elements, e.g., 2N(N−1) elements are needed for an N×N crossbar arrangement [2,8]. What is needed is a technique to reduce the number of 2×2 switch elements needed to implement both dilated and non-dilated types of N×N nonblocking switching networks.

### SUMMARY OF THE INVENTION

In accordance with the apparatus and method of the present invention, a 4×4 nonblocking switching arrangement utilizes a minimum number of eight 2×2 elements. The switch is nonblocking in that it is characterized by an algorithm that allows the destination of any two input signals to be interchanged by only changing the setting of one particular 2×2 switch. By removing one signal path a nonblocking 3×3 switch is obtained. Both switches have the minimum number of elements. These arrangements can be used as building blocks to construct larger switches and can be dilated to minimize crosstalk.

More particularly, a 4×4 nonblocking switch is disclosed for providing a switch connection between any of four inlets to any of four outlets. The 4×4 switch comprises an array of eight 2×2 nonblocking switch elements arranged in four columns, each 2×2 switch element being set to a through or bar state in response to a control signal. Four input signals are respectively applied to the four inlets of the 2×2 switch elements of the first column. Each pair of adjacent columns has the property that each element of either column is connected to both elements of the other column. Thus, 4 paths are formed, from the four inlets to the four outlets of the 4×4 switch, and each 2×2 element is traversed by two particular paths.

In another embodiment, a dilated 4×4 nonblocking switch provides a switch connection between any of four inlets to any of four outlets, and the 4×4 switch comprises an array of twenty 2×2 nonblocking switch elements arranged in five columns of four elements each. Each of the 2×2 switch elements are set into a through or bar state in response to a control signal. Four input signals are applied to the switch, but in this embodiment a simple control algorithm now causes each element to be traversed by only one signal. Moreover, the connections formed by the links between consecutive columns must satisfy two conditions. The first condition is that each pair of consecutive columns must be characterized by a graph forming two separate loops. Each loop must include four vertexes and four edges, respectively formed by four 2×2 elements and four links between these elements. The second condition is that any three consecutive columns must form a single graph that cannot be partitioned into separate graphs.

Other embodiments minimize waveguide crossings between columns, minimize crosstalk, form a nonblocking 3×3 switch by removing one signal path, enable nonblocking operation when all elements are set at the same logical state, enable the destination of two signals to be interchanged by changing the logical state of one element, and use the 4×4 switches as building blocks to construct larger switches.

### BRIEF DESCRIPTION OF THE DRAWINGS

In the drawings,

FIG. 1a shows a first illustrative embodiment of my inventive nonblocking 4×4 switch arrangement implemented using an array of eight 2×2 switches arranged in four columns. Also shown in FIG. 1a is a particular nonblocking state. FIG. 1b shows a table indicating for this state which element should be used to switch different pairs of signal paths;

FIG. 2 shows a second illustrative embodiment of a nonblocking 4×4 switch arrangement in accordance with the present invention. Also shown is a particular nonblocking state, obtained by choosing the same (bar) setting for all elements;

FIG. 3 shows a third illustrative embodiment of a nonblocking 4×4 switch arrangement in accordance with the present invention. Also shown is a particular nonblocking state, obtained by choosing the same (bar) setting for all elements;

FIG. 4 shows an illustrative embodiment of a nonblocking 3×3 switch arrangement, FIG. 4b, derived from the 4×4 switch arrangement of FIG. 4a;

FIG. 5a shows a diagram of a nondilated switch element. FIG. 5b shows a dilated switch arrangement. FIG. 5c shows that when two dilated arrangements are connected together, each connection includes a redundant element that can be removed;

FIG. 6 illustrates the two steps involved in the derivation of the dilated arrangement of FIG. 7 from FIG. 1. The first step replaces each element with a dilated arrangement of four elements, and it transforms for instance the first two columns of FIG. 1 into the four columns of FIG. 6a. The second step then removes redundant elements, and it can be carried out in different ways. By removing for instance the second and third columns one obtains FIG. 6b, giving the first two columns of FIG. 7;

FIG. 7 shows a diagram of a dilated version of the 4×4 switch arrangement of FIG. 1. Notice the arrangement has 20 waveguide crossings;

FIG. 8 shows a diagram of a dilated 2×2 arrangement of two elements used in the prior art;

FIG. 9 shows a switch having two separate loops formed by two consecutive columns;

FIG. 10a shows a switch having consecutive columns that do not form separate loops. In FIG. 10b, the last column is redundant;

FIG. 11 shows a 8×8 crossbar switch construction of a nonblocking 2N×2N arrangement using four nonblocking N×N blocks combined with 1×2 and 2×1 elements;

FIG. 12 shows a 8×8 nonblocking arrangement with minimum depth;

FIG. 13 shows a nonblocking Clos arrangement with m=2;

FIG. 14a shows a fully dilated m×(2m−1) switch realized for m=2 with 7 elements and one waveguide crossing. The switch is a crossbar arrangement consisting of two 1×3 binary trees and three 2×1 trees as shown in FIG. 4b;

FIG. 15 shows how a m×(2m−1) switch, FIG. 15b, is realized by first combining together two m×(2m) blocks, FIG. 15a, and then removing one output port from one of the two blocks;

FIG. 16a shows a fully dilated Clos arrangement realized for m=2 wihout removing redundant elements. The final result, by removing the elements Pᵢ, is shown in FIG. 16b. Alternatively, one can remove the dual elements Pᵢ and;

FIG. 17 shows a 2×2 switch element implementated as a wavelength interchanger.

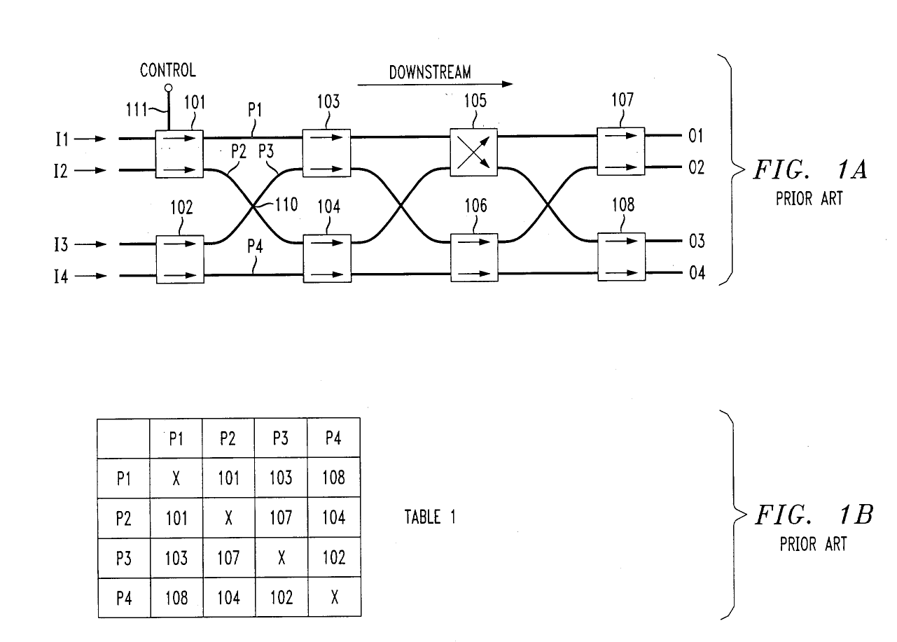

In the following description, identical element designations in different figures represent identical elements. Additionally in the element designations, the first digit refers to the figure in which that element is first located (e.g., 102 is first located in FIG. 1).

### DETAILED DESCRIPTION

In accordance with the present invention, I describe a 4×4 nonblocking switching arrangement implemented using a minimum number of eight 2×2 elements. A nonblocking switch is required for most optical crossconnects. The switch is nonblocking in the wide sense in that it is characterized by an algorithm that allows the destination of any two input signals to be interchanged without essentially affecting all other signals. Indeed, the switch is characterized by an algorithm that allows the destination of any two signals to be interchanged by simply changing the setting of one particular 2×2 switch, thus interchanging the two signals without affecting the other signals. Shown in FIG. 1a is a first illustrative embodiment of a nonblocking 4×4 switch arrangement in accordance with the present invention. In FIG. 1a, the nonblocking 4×4 switch arrangement includes 8 elements, 101-108, with a minimum number (three) of waveguide crossings, 110. The operating state of each of the elements 101-108 is externally controlled by a control signal, e.g., 111, to be in either a bar state, e.g., 101 or cross state 105. A first control signal state (e.g., logic 0) activates the bar (=) state which, as shown, connects together the upper inlet of the element to the upper outlet and the lower inlet to the lower outlet. A second control signal state (e.g., logic 1) activates the cross (X) state which, as shown, connects the upper inlet to the lower outlet and the lower inlet to the upper outlet. FIG. 1a also shows a particular nonblocking configuration, obtained by choosing the settings (values) of the various elements so that each pair of output signals can be interchanged by simply changing the setting of one element. Any such configuration is called a nonblocking state of the 4×4 switch.

In accordance with the teachings of the present invention, the 4×4 switch of FIG. 1a satisfies the following three conditions, when all four input signals 1, 2, 3, and 4 are active. First, each 2×2 element 101-108 receives exactly two signals. This condition insures that each element is a crosspoint of intersection for two signals, which can thus be interchanged by the element in question. Second, the arrangement is characterized by a set of nonblocking states, each having the property that each signal path P1-P4 has at least one intersection. Such configuration is called a nonblocking state because any pair of paths can be interchanged by the changing the setting of one particular switch element (via the control signal 111). Finally, the third and last property is that it is possible, when the arrangement is in a nonblocking state, to interchange any two particular signals by changing the setting of only one element, such that the resulting state is again nonbocking. Because of the above three properties, the arrangement of FIG. 1a is nonblocking in the wide sense. As shown in FIG. 1a, I have discovered that a nonblocking 4×4 switch arrangement can be realized by using only 8 elements, and that 8 is the minimum number of elements. In order to realize the above conditions, the eight elements must be arranged in four columns of two elements each. Any arrangement of this type will have the above properties, provided the two outlets of each element are connected to different elements of the next downstream column. This condition is required to insure that the arrangement does not include redundant elements, which could otherwise be removed without affecting the combinatorial properties of the arrangement. Three examples are shown in FIGS. 1-3.

FIG. 1a shows the setting (bar or cross) of each of element 101-108 for a particular nonblocking state satisfying the second and third condition. All other nonblocking states are established by an algorithm discussed in a later paragraph. For the particular state of FIG. 1a, elements 101 or 105 can interchange inputs I1 and I2 (i.e., paths P1 and P2); element 103 can interchange inputs I1 and I3 (i.e., paths P1 and P3); element 108 can interchange inputs I1 and I4 (i.e., paths P1 and P4); element 107 can interchange inputs I2 and I3 (i.e., paths P2 and P3); element 104 can interchange inputs I2 and I4 (i.e., paths P2 and P4); and element 102 or 106 can interchange inputs I3 and I4 (i.e., paths P3 and P4).

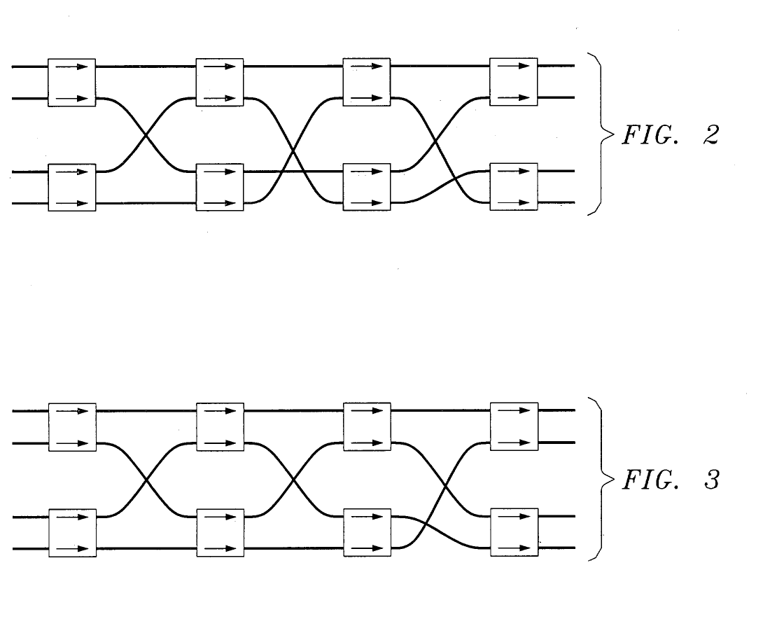

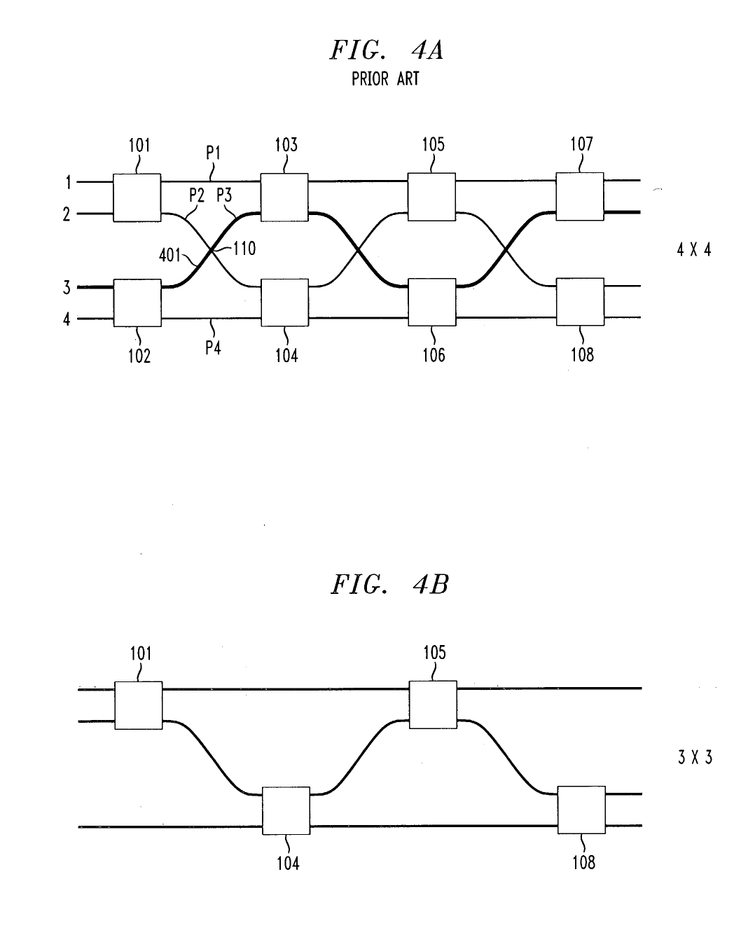

The FIG. 1a embodiment is attractive for realization in integrated form since it requires the least number of waveguide crossings. On the other hand, this arrangement can be shown to have the property that the zero state, obtained by setting all elements in the bar state, is not allowed because it is blocking. Also blocking is the state with all elements in the cross state. Thus in FIG. 1a, the two states with all the elements set to the same logical value are not allowed. For this reason it is generally preferable, if the switch is not required in integrated form, to choose the arrangement of FIG. 2. In this case the above two blocking states become nonblocking and the same result is obtained in FIG. 3. In FIG. 2 one also obtains for these two states the property that any particular element can be switched without producing a blocking state. The alternate arrangements of FIGS. 2 and 3, like that of FIG. 1a, all satisfy the three of the above-discussed conditions. The technique illustrated in FIGS. 1-3 equally applies to the construction of a conventional switch, or a channel adding/dropping filter.

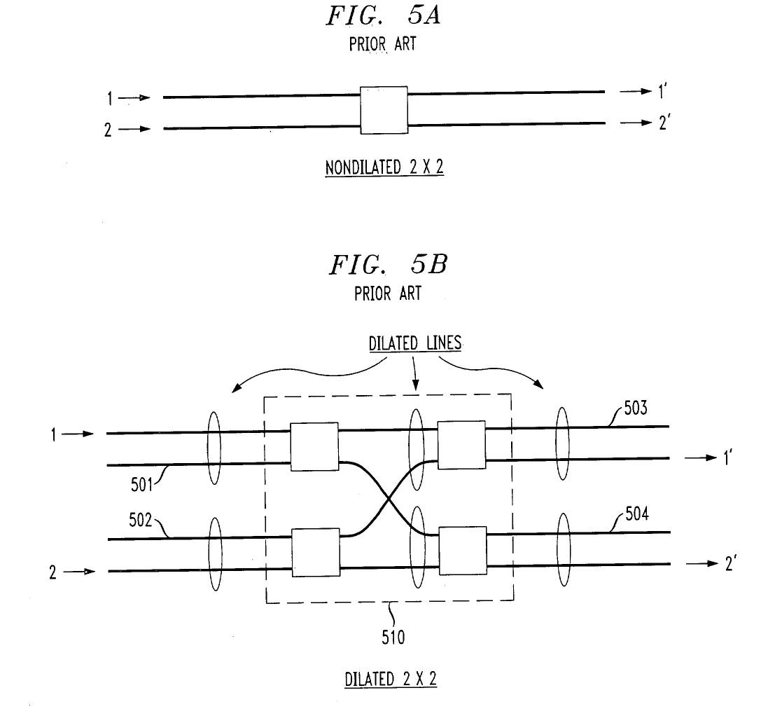

An important property of the above 4×4 arrangements is that they can be reduced to nonblocking 3×3 arrangements as shown in FIGS. 4a and 4b. By removing one signal path and all elements connected to that path, one obtains a nonblocking 3×3 arrangement of 4 elements. Thus, the 3×3 of FIG. 4b is derived from FIG. 4a by removing path P3 and associated elements 102, 103, 106, and 107. One finds that the resulting switch structure has the minimum number of elements for a nonblocking 3×3 switch. In this case each column contains only one element, and the above three conditions, and the above algorithm still apply. In the particular example of FIG. 4b, the 3×3 arrangement is implemented entirely without waveguides crossings (110). This is a consequence of the fact that FIG. 4a has only three crossings. These arrangements are used as building blocks to construct larger switches that can be dilated to minimize crosstalk.

1. Algorithm

In accordance with the present invention, a simple algorithm is described specifying which elements cannot be switched, in order to avoid a nonblocking state as specified by the above third condition. The same algorithm applies to 3×3 and 4×4 switch arrangements.

One can verify that the type of arrangement under consideration is characterized by a nonempty set of nonblocking states. One can also verify that any of these is allowed. In fact, for each nonblocking state one can show that it is possible, by the following algorithm, to interchange any two paths by changing the setting (the logical value) of only one element without producing a blocking state. One can verify that it is sufficient (and necessary) to this purpose to satisfy the following rule: Never change an intermediate element unless necessary. By this rule, an element in the second or third column can only be changed if the element in question is the only crosspoint for the two signals that must be interchanged. With reference to the table in FIG. 1b, the designation of an element which should be used to switch a pair of paths is shown. Note, in accordance with the above rule, when more than one element can be used to interchange any two paths (e.g., 101 and 105 for paths P1 and P2), the exterior element (e.g., 101), rather than the interior element 105, should be used. Thus, the table of FIG. 1b shows only element 101 as proper crosspoint element to switch paths P1 and P2. Similarly to interchange paths P3 and P4, the external element 102 is used (rather than element 106). However to interchange paths P1 and P3, the interior element 103 is used since it is the only single element that can accomplish such a path interchange. The remaining path interchanges are shown in the table of FIG. 1b.

The complete algorithm is then simply: Start from a nonblocking state and then produce any desired signal path permutation as a product of elementary signal path permutations, each realized by interchanging a particular pair of signal paths.

2. Dilated Arrangements

The above arrangements can be fully dilated without changing their combinatorial properties. While an existing procedure [3] could be used for this purpose, as discussed later, it is preferred to use a different procedure that has the advantage of being more general. As discussed earlier, each element in the above arrangements is traversed by two signals (paths) and, therefore, the element extinction ratio causes crosstalk components corrupting the two signals. On the other hand, the dilated arrangements derived next are characterized by a nonblocking algorithm that guarantees that each element is exactly traversed by one signal, thus eliminating to a first approximation crosstalk caused by the element finite extinction ratio.

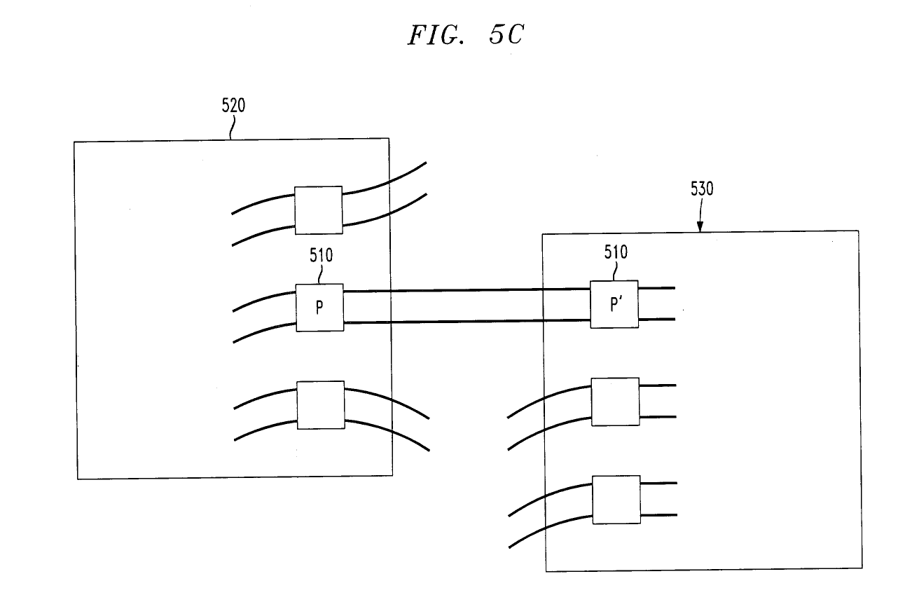

First consider the simplest case, a particular element traversed by two signals as in the example of FIG. 5a. The corresponding dilated arrangement in this case simply consists of four elements arranged as in FIG. 5b. In the dilated arrangement, each input and output element still has a pair of lines, one of which is idle. Thus in FIG. 5b, lines 501-504 are idle. Accordingly we impose on the dilated arrangements, described next, the restriction that each element (or dilated line, formed by a pair of lines), must carry only one signal. Under this constraint, the dilated 2×2 arrangement of FIG. 5b is capable of the same (two) permutations (cross, bar) performed by the conventional, non-dilated, 2×2 element of FIG. 5a. Notice that the dilated 2×2 arrangement 510 of FIG. 5b is implemented by using four 2×2 elements of FIG. 5a that are essentially operated as 1×2 and 2×1 elements.

As shown in FIG. 5c, consider two dilated arrangements 520 and 530, characterized by suitable algorithms causing each element to be traversed by only one signal, and let a dilated line of either arrangement be connected to a dilated line of the other arrangement. This clearly produces two dilated elements 510 that are directly connected together. It is therefore concluded that whenever two dilated arrangements are connected together, each connection produces a redundant element, which can be removed.

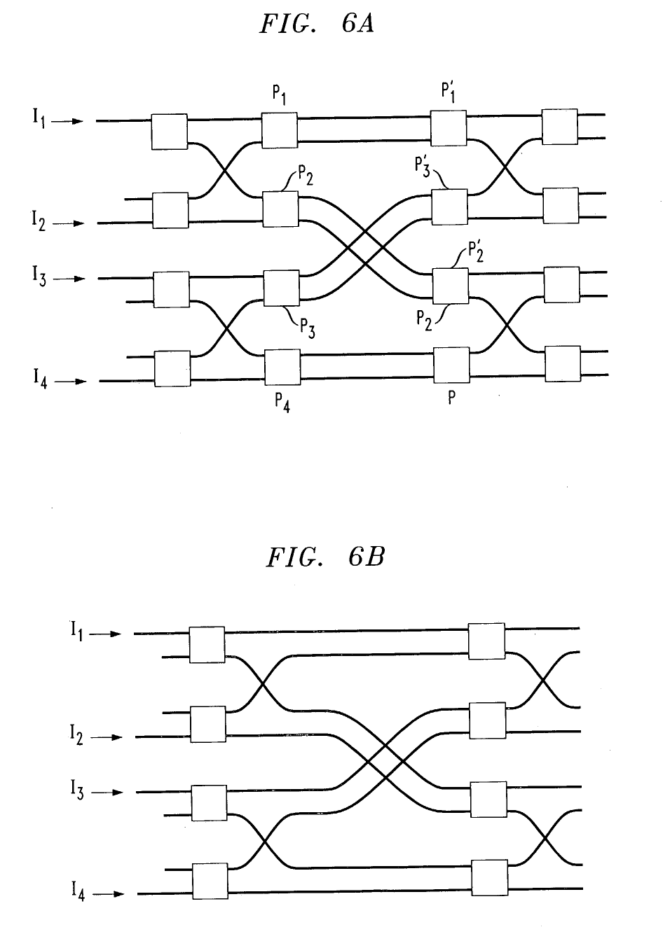

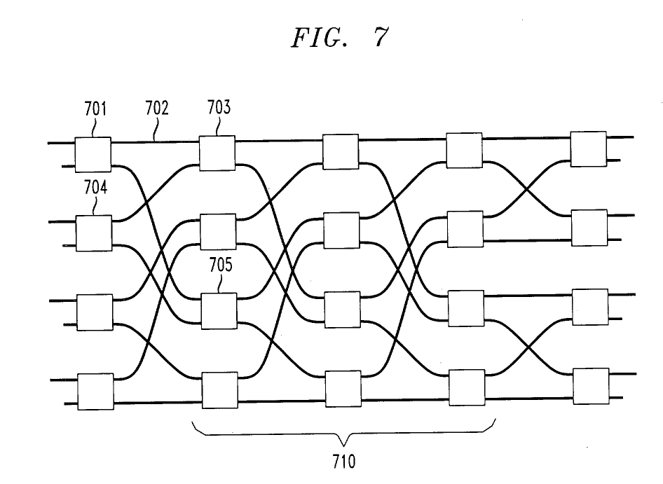

In the following paragraphs the dilation of FIGS. 1-3 are discussed. Dilation proceeds in two steps. First, we replace each 2×2 element of FIGS. 1-3 with a dilated 2×2 element 510 of FIG. 5 as shown in FIG. 6a. Second, we remove redundant elements as shown in FIG. 6b. The first step doubles the number of columns and the number of elements in each column. The second step reduces the number of columns, and it can be carried out in different ways, since either one of each pair of (dual) elements in FIG. 6a can be removed. Therefore several equivalent (isomorphic) arrangements are obtained. Some of these, those minimizing waveguide crossings, are generally preferable. An example, shown in FIG. 7, is a dilated arrangement obtained from FIG. 1 after performing the first and second steps. As pointed out earlier, the dilated arrangement 510 of FIG. 5b has the same two states of a conventional 2×2 element. Therefore the arrangement of FIG. 7 is equivalent to the original arrangement of FIG. 1. That is, under the constraint that each element must be traversed by only one signal, it will perform the same permutations under the same algorithm. Thus the same control algorithm applies to both FIGS. 1 and 7.

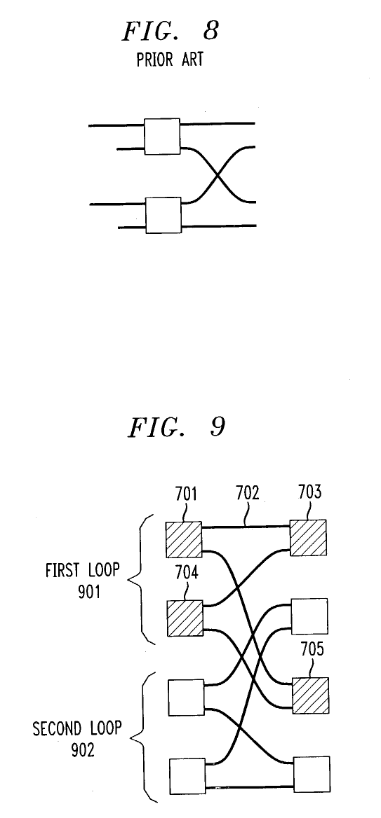

The above derivation is equivalent to the prior art method [3], which also involves two steps. The first step in [3] replaces each element with a dilated combination of two elements as in FIG. 8. Then, the second step connects each dilated line after the last column to a single element, thus forming an additional column. The present method, however, is more general in two respects. First, the present method produces a variety of equivalent (isomorphic) arrangements. Second, the present method also applies to the important case, discussed later, of a network constructed by combining several dilated building blocks, some of which need not be realized by the above procedure. In the construction of such a network, the present method will again produce a variety of equivalent arrangements, obtained by removing different redundant elements.

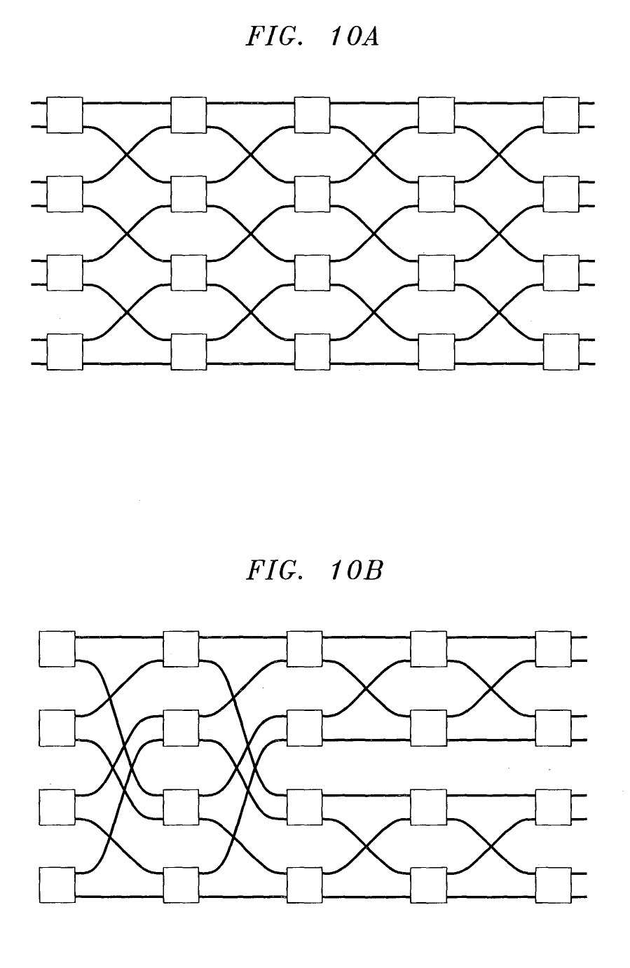

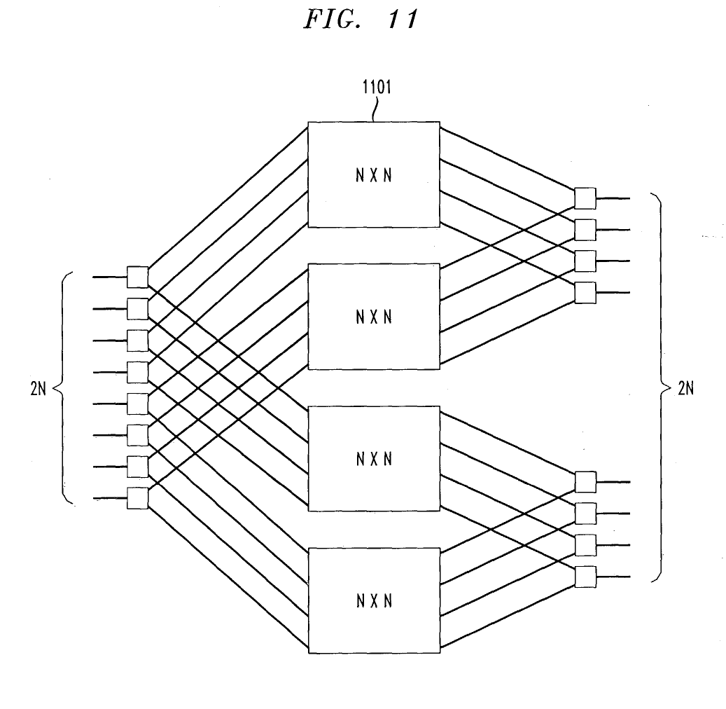

The above derivation implies that the arrangement of FIG. 7 has the important property of being at the same time nonblocking and free of first order crosstalk. These characteristic exist for any arrangement made up of 20 elements arranged in 5 columns, as in FIG. 7, provided the arrangement satisfies two (necessary and sufficient) properties. To derive the first condition, consider two consecutive columns in FIG. 7. The two separate graphs (two closed loops), 901 and 902, shown in FIG. 9 are obtained by taking each element, e.g., 701, as a vertex and each link, e.g., 702, as an edge. Each loop is made up of two elements of one column, 701 and 704, connected to two elements, 703 and 705, of an adjacent column, and it can be recognized as the dilated arrangement of FIG. 1. Thus, FIG. 7 includes 8 closed loops (two closed loops for each adjacent pair of columns). Next, to derive the second condition, consider more than two consecutive columns in FIG. 7. The graph in this case has the property that it cannot be partitioned into separate graphs. One can verify that any arrangement consisting of 20 elements arranged in 5 columns and satisfying the above two conditions can be considered the dilated version of a nonblocking arrangement of 8 ordinary elements and, therefore, it is necessarily both nonblocking and free of (first order) crosstalk, under a suitable algorithm. The first of the above two conditions is required in order to insure that the arrangement includes 8 dilated elements and, the second condition, insures that there are no redundant elements. The two arrangements of FIGS. 10a and 10b, for instance, are both blocking, if we specify that each element must be traversed by one signal. The FIG. 10a arrangement lacks the first property and, the FIG. 10b arrangement, has redundant elements in the last two columns. Notice that in FIG. 7, in order to interchange two particular output signals, one must change the settings of four elements, since each element of FIG. 1 is now replaced by four elements, corresponding to a particular loop. Also notice that there is a one-to-one correspondence between the 8 loops of a dilated arrangement of 20 elements and the 8 elements of a nondilated arrangement. Thus, the above algorithm also applies to a dilated arrangement provided each loop is viewed as a single (dilated) 2×2 element.

3. Larger Arrangements

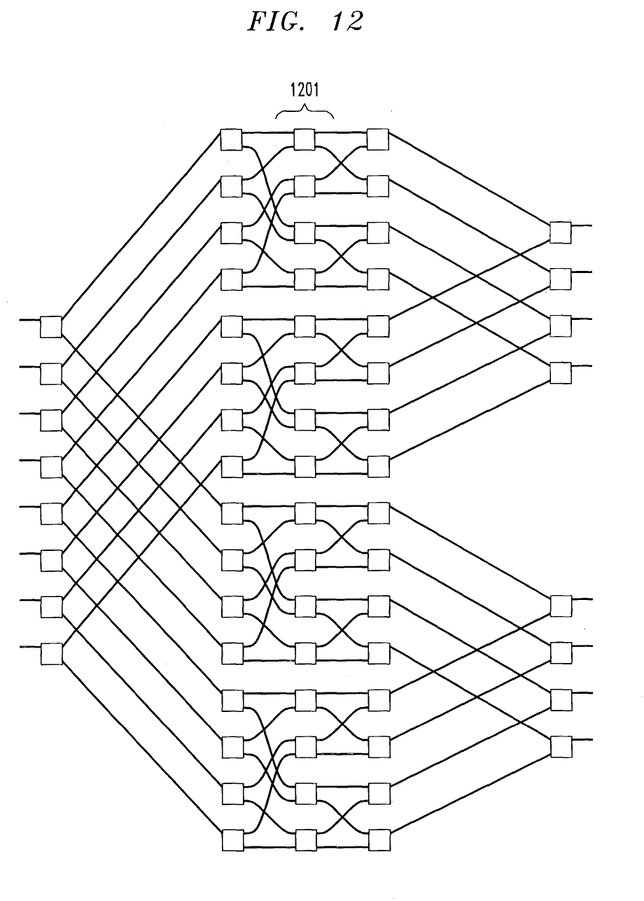

By using the arrangements of FIGS. 1 and 7 as building blocks we now construct larger arrangements. To this purpose we can use the recurrent construction property of the classical crossbar arrangement [2]. This construction consists of three stages as shown in FIG. 11, and it generates a 2N×2N arrangement by using four N×N blocks in the central stage. The elements in the input and output stages are 1×2 and 2×1 switches and therefore the entire arrangement is fully dilated (each element is traversed by at most one signal), if fully dilated blocks are used in the central stage. Notice the arrangement is nonblocking if its constituents are nonblocking.

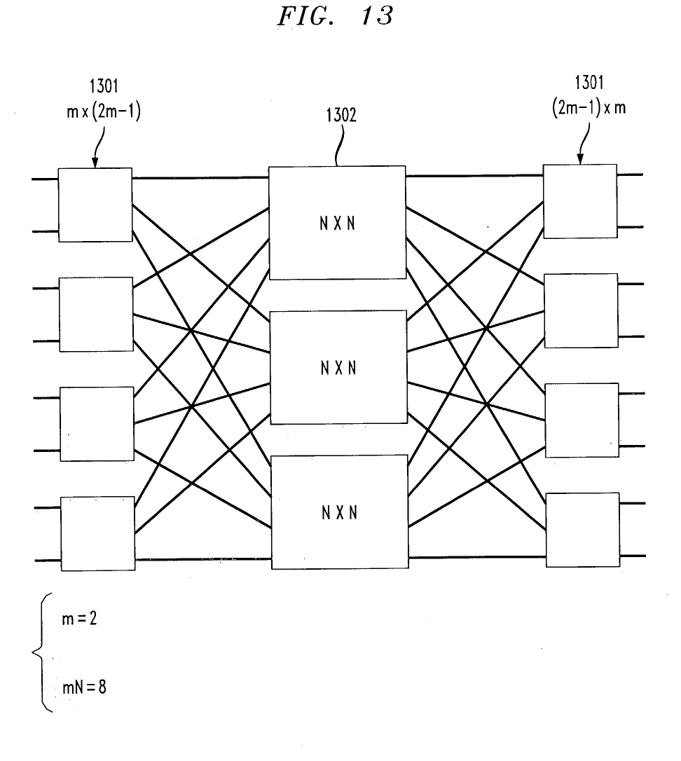

For N=4, one can realize each central block 1101 in FIG. 11 by using the arrangement of FIG. 1 or, alternatively, one can use a fully dilated arrangement as in FIG. 7 in which case the entire arrangement is fully dilated. In the latter case, by removing the first two columns in FIG. 7, one obtains the nonblocking partially dilated 8×8 switch arrangement of FIG. 12. This arrangement has minimum number of columns, but it is not fully dilated, since an element in the central column 1201 may now receive two signals, and crosstalk is then caused by the finite extinction ratio of elements in the central column 1201.

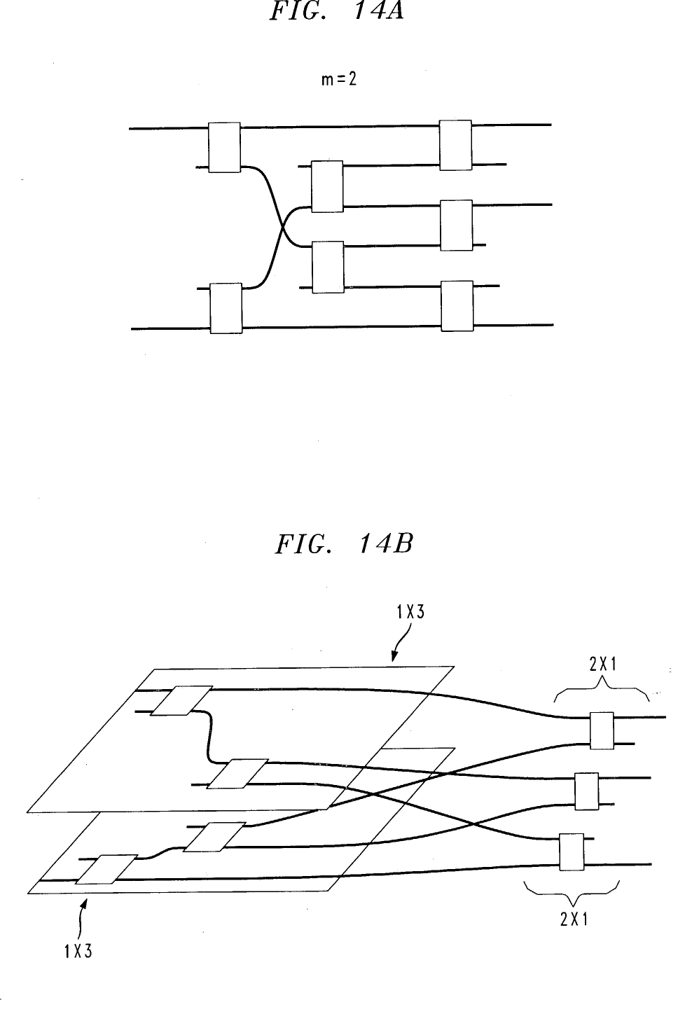

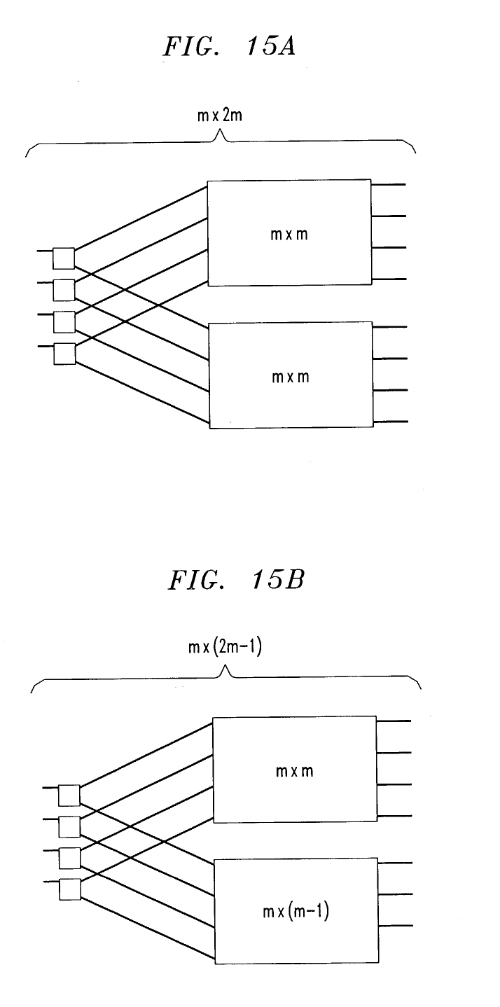

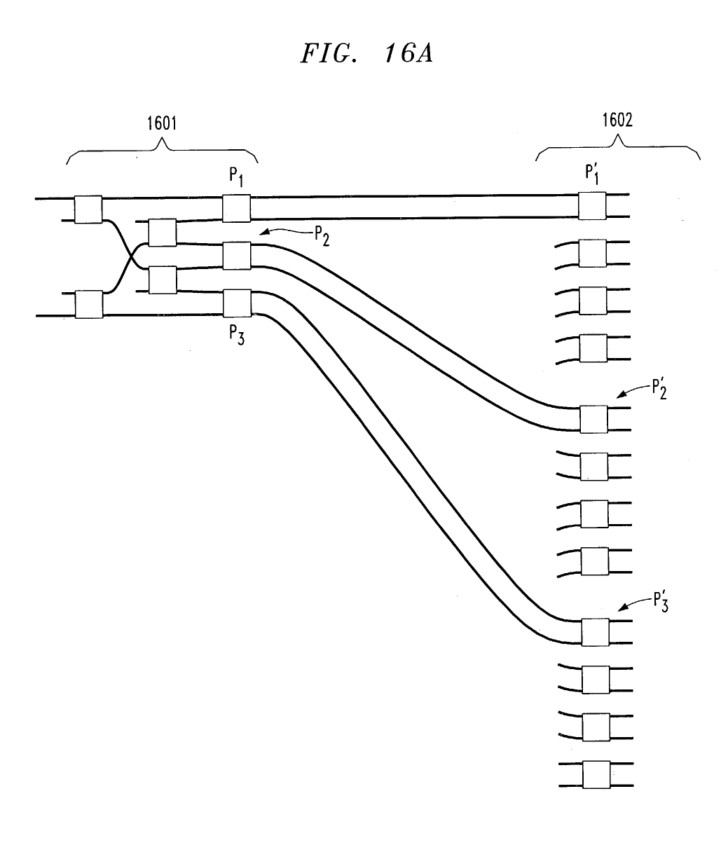

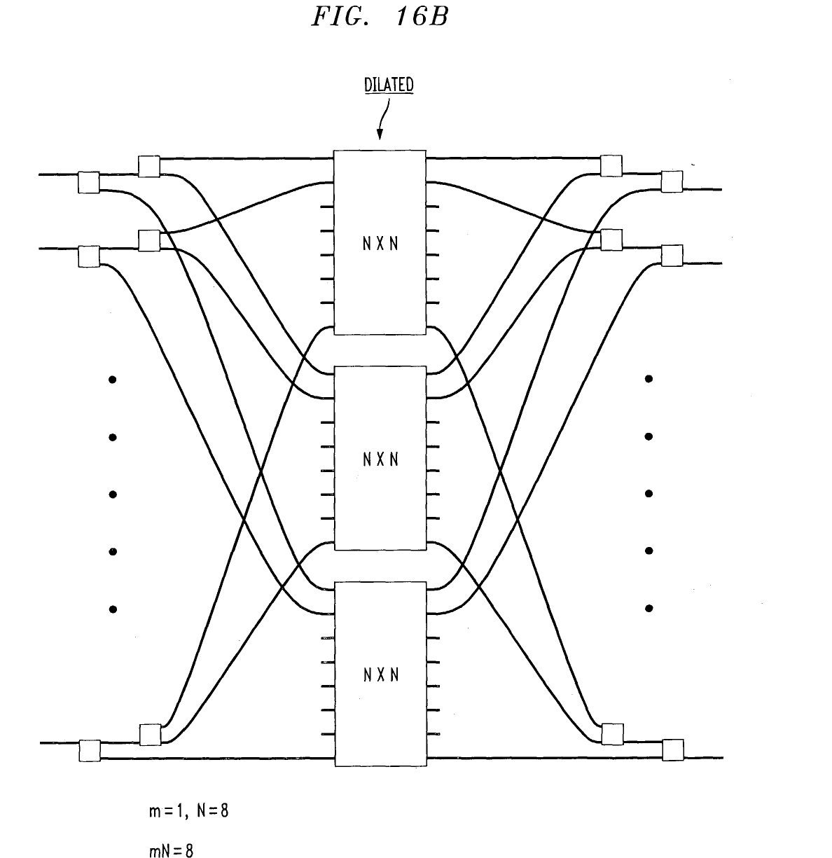

An attractive alternative to the above arrangements is Clos construction [13], which has the advantage of, in general, requiring fewer elements. This construction generates a mN×mN arrangement by using N×N blocks in the central stage 1101 and m×(2m−1) blocks in the input and output stages. Shown in FIG. 13 is a mN×mN arrangement where m=2 and mN=8, the result is an 8×8 arrangement. A non-dilated Clos arrangement may be made by implementing the input and output stages using m×(2m−1) blocks 1301, and by implementing the central stage using N×N blocks 1101, constructed as shown in FIGS. 1-4. The Clos arrangement can be made partially dilated if each m×(2m−1) block 1301 is made fully dilated as shown, for example, in FIG. 14 for m=2 and in FIGS. 15a and 15b for m>2. By also dilating the central N×N block 1302, the entire Clos arrangement is then fully dilated. As pointed out earlier, the arrangement obtained by joining together the various blocks contains, as shown for example in FIG. 16a, redundant elements, which can be eliminated in different ways. One way is to remove the first and last column in each central block 1602, thus reducing it to only 3 columns as in FIG. 12. Alternatively, a column from each input and output block 1601 can be removed (the column which faces the central block 1602), and one then obtains, for m=2, the arrangement of FIG. 16b. Modifying the central block 1602 may be advantageous to when it is to be implemented in integrated form. Modifying the input and output blocks 1601 may be preferable when they are to be realized in integrated form. Various combinations of the above two cases are also possible, and many equivalent (isomorphic) arrangements are thus obtained. Some of these are more advantageous then others if the blocks must be realized separately in integrated form and joined together by using fibers.

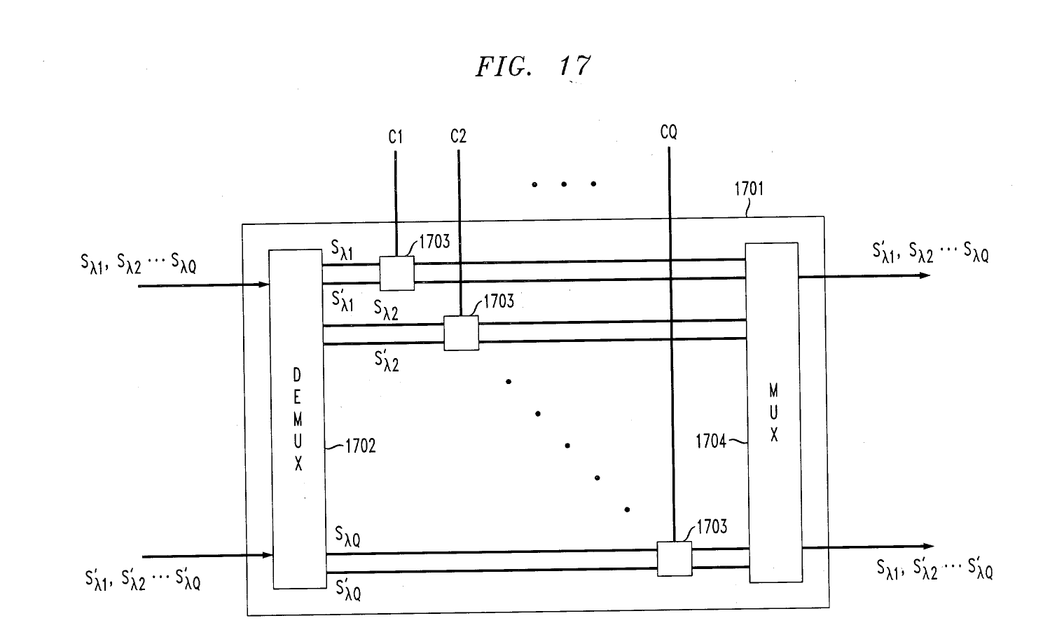

With reference to FIG. 17, there is shown a 2×2 switch element implementated as a wavelength interchanger 1701. The interchanger 1701 includes a demultiplexer 1702, a plurality of 2×2 switch elements 1703, and a multiplexer 1704. The interchanger 1701 enables each individual wavelength of the two multiplexed input signals S_{λ1}, S_{λ2} - - - S_{λQ} and S′_{λ1}, S′_{λ2} - - - S′_{λQ}, each consisting of Q wavelength channels of wavelengths λ1, λ2, - - - λQ. The interchanger 1701 enables each pair of wavelength channels of the same wavelength to be independently switched at one of the 2×2 switch elements 1703 under control of an associated individual control signal C₁, C₂ - - - C_{Q}. In the example shown, the control signal C₁ is used to activate the first 2×2 switch, to switch the first wavelengths S_{λ1} and S′_{λ1}, of wavelength λ1 of the two input signals S_{λ1}, S_{λ2} - - - S_{λQ} and S′_{λ1}, S′_{λ2} - - - S′_{λQ}, respectively, to form the two output signals S′_{λ1}, S_{λ2} - - - S_{λQ} and S_{λ1}, S′_{λ2} - - - S′_{λQ}, respectively.

What has been described is merely illustrative of the application of the principles of the present invention. Other methods and arrangements can be implemented by those skilled in the art without departing from the spirit and scope of the present invention.

### APPENDIX

### REFERENCES

[1] Alferness, R. C., “Guided-wave Devices for Optical Communications,” IEEE J. Quantum Electron., Vol. QE-17, pp. 946-957, 1981.

[2] Padmanabhan, K., and Netravali, A., “Dilated Networks for Photonic Switching,” IEEE Transactions on Communications, Vol. COM-35, No. 12, pp. 1357-1365, December 1987. Also see U.S. Pat. No 5,018,129, “Dual Rail Dilated Switch Networks,” filed Mar. 9, 1989 and issued on May 21, 1991

[3] Ramaswami, R. and Sivarajan, K. N., “Optical Networks: A Practical Perspective,” San Francisco, Calif; Morgan Kaufmann, 1998.

[4] Spanke, R. A., “Architectures for Guided-wave Optical Ioptical Space Switching Systems,” IEEE Communications Magazine, 25 (5), pp. 42-48, May 1987.

[5] Nishi, T., Yamamoto, T., and Kuroyanagi, S., “A Polarization-Controlled Free-Space Photonic Switch Based on a PI-Loss Switch,” IEEE Photon. Technol. Lett., Vol. 6, No. 9, pp. 1104-1106, September 1993.

[6] Kondo, M., Takado, N, Komatsu, K., and Ohta, Y., “32 Switch Elements Integrated Low Crosstalk LiNbO3 4×4 Optical Matrix Switch,” IOOC-ECOC 85, Venice, pp. 361-364, 1985.

[7] Goh, T., Himeno, A., Okuno, M., Takahashi, H., and Hattori, K., “High-Extinction Ratio and Low Loss Silica-Based 8×8 Thermooptic Matrix Switch,” IEEE Photon. Technol. Lett., Vol. 10, No. 3, pp. 358-360, March 1998.

[8] Hamamoto, H., Anan, T., Komatsu, K., Sugimoto, M., and Mito, I., “First 8×8 Semiconductor Optical Matrix Switches Using GaAs/AlGaAs Electro-optic Guided-wave Directional Couplers,” Electron. Lett., vol. 28, pp. 441-443, 1992.

[9] Granestrand, P., Lagerstrom, B., Svensson, P., Olofsson, H., Falk, J. E., and Stoltz, B., “Pigtailed Tree-structured 8×8 LiNbO₃ Switch Matrix with 112 Digital Optical Switches,” IEEE Photon. Technol. Lett., Vol. 6, pp. 71-73, 1994.

[10] Murphy, E. J., Murphy, T. O., Ambrose, A. F., Irvin, R. W., Lee, B. H., Peng, P., Richards, G. W., and Yorinks, A., “16×16 Strictly Nonblocking Guided-wave Optical Switching System,” J/Lightwave Technol., Vol. 10, pp. 810-812, 1998.

[11] Doerr, C. R., “Proposed WDM Cross Connect Using a Planar Arrangement of Waveguide Grating Routers and Phase Shifters,” IEEE Photon. Technol. Lett., Vol. 10, No. 4, pp. 528-530, April 1998.

[12] Doerr, C. R., Stulz, L. W., Gates, J., Cappuzzo, M., Laskowski, E., Gomez, L., Paunescu, A., White, A., and Narayanan, C., “Arrayed Waveguide Lens Wavelength Add-Drop in Silica,” IEEE Photon. Technol. Lett., Vol. 11, No. 5, pp. 557-559, May 1999.

[13] Clos, C., “A Study of Non-blocking Switching Networks,” B.S.T.J., 32, 1953, pp. 406-424.

[14] Spanke, R. A., and Benes, V. E., “An n-stage Planar Optical Permutation Network,” Applied Optics, 26, April 1987.

What is claimed is:

1. A 4×4 nonblocking switch for providing a switch connection between any of four inlets to any of four outlets, the 4×4 switch comprising
an array of eight 2×2 nonblocking switch elements arranged in four columns, each 2×2 switch element being set to a cross or bar state in response to a control signal;
two of the four inlets of the 4×4 switch connect to two inlets of a first 2×2 switch of a first column and the other two inlets of the 4×4 switch connect to two inlets of a second 2×2 switch element of the first column;
two of the outlets of the 4×4 switch connect to two outlets of a first 2×2 switch element of a fourth column and the other two outlets of the 4×4 switch connect to two outlets of a second 2×2 switch element of the fourth column; and
wherein each 2×2 switch element of each column, except the last column, is connected to two different 2×2 switch elements of an adjacent downstream column, and each connection is formed by a waveguide link.

2. The 4×4 switch of claim 1 wherein
a nonblocking 3×3 switch is formed by deleting the links forming a particular connection path from one of four inlets through to one of the four outlets of the 4×4 switch.

3. The 4×4 switch of claim 2 wherein all 2×2 switch elements connected to the deleted links are eliminated.

4. The 4×4 switch of claim 1 wherein
a connection between one of the two inlets and one of the two outlets of each of the 2×2 switches is controlled by a control signal; and wherein
any two output signals of the 4×4 switch can be interchanged by changing the control signal to only one of the 2×2 switch elements.

5. The 4×4 switch of claim 1 wherein there is only one waveguide crossover between 2×2 switch elements of adjacent columns.

6. The 4×4 switch of claim 1 wherein each input/output path crosses all other input/output paths if all 2×2 switch elements are set to the same setting.

7. The 4×4 switch of claim 6 wherein each input/output path crosses all other input/output paths if all 2×2 switch elements except one are set to the same setting.

8. The 4×4 switch of claim 1 wherein each of the input signals includes Q wavelength channels of the same set of wavelengths λ1, λ2 - - - λQ and at least one of the 2×2 switch element is a wavelength interchanger which can, in response to a control signal, interchange any two channels of the same wavelength received by said at least one of the 2×2 switch element.

9. The 4×4 switch of claim 1 wherein each of the input signals includes Q wavelength channels of the same set of wavelengths λ1, λ2 - - - λQ and the 2×2 switch elements are wavelength interchangers, each 2×2 switch element can, in response to a control signal, interchange any two channels of the same wavelength received by the 2×2 switch element.

10. A method of operating a 4×4 switch including an array of eight 2×2 nonblocking switch elements arranged in four columns, each 2×2 switch element being set to a through or bar state in response to a control signal, and each 2×2 switch element of each column, except the last column, being connected to two different 2×2 switch elements of an adjacent downstream column, each connection being formed by a waveguide link, the method comprising the steps of:
initially setting the 4×4 switch in a nonblocking state such that the 4×4 switch outlet destinations of each pair of the four inputs to the 4×4 switch may be interchanged by changing the setting of a common 2×2 switch element to which the input signal pair commonly connect, and wherein,
when the input signal pair commonly connects to more than one common 2×2 switch element, changing only the setting of a common 2×2 switch element that belongs to the first or last column of the 4×4 switch to interchange the input signal pair.

11. An 8×8 nonblocking switch comprising an input stage, an output stage, and a central stage connected between the input and output stages, the central stage implemented using four of said 4×4 switches of claim 1 arranged in a column and the input and output stages implemented using 1×2 and 2×1 switch elements.

12. An 8×8 nonblocking switch comprising
(1) four of the nonblocking 4×4 switches of claim 1 arranged in one column;
(2) an input stage having each of eight inlets of the 8×8 switch connected to an inlet of a different one of eight 1×2 input switches; and
(3) an output stage having each of eight outlets of the 8×8 switch connected to an outlet of a different one of eight 2×1 output switches;
(4) where the respective inlets to a first and third 4×4 switches of the column connect to different outlets of a respective input switch of a first group of four input 1×2 switches and where the respective four inlets to a second and fourth 4×4 switch of the column connect to different outlets of a respective input switch of a second group of four 1×2 switches; and
(5) where the respective outlets of the first and second 4×4 switches connect to different inlets of the same output 2×1 switch of a first group of 2×1 switches and where the respective outlets of the second and fourth 4×4 switches connect to different inlets to the same 2×1 switch of a second group of output 2×1 switches.

13. A dilated nonblocking 4×4 switch for providing a switch connection between any of four input signals to any of four output signals, the 4×4 switch comprising
an array of twenty 2×2 nonblocking switch elements arranged in five columns of four 2×2 switch elements each, each 2×2 switch element of a first column having one of its two inlets connected to a different one of the four inlets to the 4×4 switch, each 2×2 switch element of a fifth column having one of its outlets connected to a different one of the four outlets of the 4×4 switch, and each 2×2 switch element being set into a through or bar state in response to a control signal;
wherein between any pair of adjacent columns of the first five columns, a particular pair of 2×2 switch elements of a particular column and a particular pair of 2×2 switch elements of an adjacent column form a separate closed loop that includes four 2×2 switch elements;
wherein the remaining four elements of the two adjacent columns form a separate closed loop that includes four 2×2 switch elements; and
wherein the 2×2 switch elements of any three consecutive columns form a single graph that is not made of separate graphs.

14. The dilated nonblocking 4×4 switch of claim 13 arranged to have its first two columns removed, thereby forming a nonblocking switch 4×4 switch.

15. The dilated nonblocking 4×4 switch of claim 13 arranged as part of a dilated 8×8 switch including an input stage, an output stage, and a central stage connected between the input and output stages, the central stage implemented using four of the dilated 4×4 switches of claim 12 arranged in a column.

16. The 4×4 switch of claim 1 arranged as part of a nonblocking 8×8 Clos switch arrangement including an input stage with four 2×3 input switches, an output stage with four 3×2 output switches, and a central stage connected between the input and output stages, the central stage implemented using three of the 4×4 switches of claim 1 arranged in a column.

16. The 4×4 switch of claim 14 arranged as part of a nonblocking 8×8 Clos switch arrangement including an input stage with four 2×3 input switches, an output stage with four 3×2 output switches, and a central stage connected between the input and output stages, the central stage implemented using three of the 4×4 switches of claim 13 arranged in a column.

17. The 4×4 switch of claim 13 arranged as part of a nonblocking 8×8 Clos switch arrangement including an input stage with four 2×3 input switches, an output stage with four 3×2 output switches, and a central stage connected between the input and output stages, the central stage implemented using three of the 4×4 switches of claim 12 arranged in a column.

18. The 4×4 switch of claim 14 arranged as part of a nonblocking 8×8 Clos switch including an input stage with four dilated 2×3 input switches, an output stage with four dilated 3×2 output switches, and a central stage connected between the input and output stages, the central stage implemented using three of the 4×4 switches of claim 13 arranged in a column.

19. The 4×4 switch of claim 13 arranged as part of a nonblocking 8×8 Clos switch arrangement including an input stage with four dilated 2×3 input switches, an output stage with four dilated 3×2 output switches, and a central stage connected between the input and output stages, the central stage implemented using three of the 4×4 switches of claim 12 arranged in a column and wherein redundant elements of the input and output stages are removed.

20. A nonblocking fully dilated mN×mN Clos switch arrangement having three fully dilated stages comprising
an input stage using m×(2m−1) switches,
an output stage using (2m−1)×m switches,
a central stage, connected between the input and output stages, using N×N switches, and wherein
(1) redundant switch elements of the input stage which interface to the central stage or switch elements of the central stage which interface to the input stage are removed, and
(2) redundant switch elements of the output stage which interface to the central stage or switch elements of the central stage which interface to the output stage are removed.

21. The 4×4 switch of claim 12 wherein the links between the various columns form a total of 20 waveguide crossings.

22. A method of operating a dilated nonblocking 4×4 switch for providing a switch connection between any of four inlets to any of four outlets, the 4×4 switch including an array of twenty 2×2 nonblocking switch elements arranged in five columns of four 2×2 switch elements each, each 2×2 switch element being set into a through or bar state in response to a control signal, groups of four of the 2×2 elements in adjacent columns interconnected in a loop thereby forming a dilated 2×2 switch element, the 4×4 switch including eight of such dilated 2×2 switch elements, the method comprising the steps of
initially setting the 4×4 switch in a nonblocking state such that the 4×4 switch outlet destinations of each pair of the four input signals to the 4×4 switch may be interchanged by changing the setting of each of the four 2×2 switch elements of the dilated 2×2 switch element to which the input signal pair commonly connect, and wherein,
when the input signal pair commonly connects to more than one dilated 2×2 switch element, changing only the setting of a dilated 2×2 switch element that belongs to the first or last column of the 4×4 switch to interchange the input signal pair.
